(19) United States
(12) Patent Application Publication
(10) Pub. No.: US 2010/0191624 A1
(43) Pub. Date: Jul. 29, 2010

(54) SYSTEM AND METHOD FOR CLASSIFYING REQUESTS

(75) Inventors: Azriel Razi Sharir, Ein Vered (IL); Alon Tam, Holon (IL); Ronen Mintz, Givatim (IL)

Correspondence Address: SPRINKLE IP LAW GROUP, 1301 W. 25TH STREET, SUITE 408, AUSTIN, TX, 78705, US

(73) Assignee: BMC Software, Inc., Houston, TX (US)

(21) Appl. No.: 12/440,218

(22) PCT Filed: Sep. 5, 2007
(86) PCT No.: PCT/US07/19374

§ 371 Date: Aug. 4, 2009

Related U.S. Application Data
(63) Continuation-in-part of application No. 11/515,655, filed on Sep. 5, 2006, now abandoned.

(51) Int. Cl. G06F 17/30; G06Q 10/00; G06Q 30/00; G06F 15/16

(52) U.S. Cl. 705/30; 707/705; 709/203; 707/E17.009

(57) ABSTRACT

Embodiments of the present invention generate identification rules to classify requests as corresponding to particular transactions. Embodiments of the present invention examine a set of sample requests, determine patterns in the sample requests and generate identification rules based on the request patterns to classify subsequent requests as corresponding to particular transactions. As more sample requests are processed, embodiments of the present invention can update the identification rules. Put another way, embodiments of the present invention can automatically learn how to classify requests better as more requests are processed.

### TECHNICAL FIELD OF THE INVENTION

This invention relates generally to computer generated requests. More particularly, the present invention relates to methods and systems for identifying requests. Even more particularly, the present invention relates to a system and method for generating identification rules to classify requests as corresponding to particular transactions.

### BACKGROUND OF THE INVENTION

As web sites become more important to commerce, education, governmental functions and other aspects of society, entities controlling web sites are increasingly interested in setting performance goals and quality standards for their web sites. Particularly, entities are interested in how quickly their web servers (and related application servers) respond to defined actions by an end-user. A business, for example, may be interested in how quickly its backend servers respond in aggregate to user requests to add items to a virtual shopping cart. A particular user action on a web page, such as clicking on an “Add to Cart” button, however, may generate multiple HTTP requests, some of which may contain many parameters. The user-action action of selecting the Add to Cart button may cause, for example, the web browser to generate requests with parameters related to the particular user and item, requests for static and dynamic content and other requests. Moreover, the user action can cause different requests to be generated depending on the context of the action. For example, the same action taken by a different user can cause different HTTP requests to be generated. Thus, it is difficult to link a particular request generated by a browser to a particular user action of interest.

The classification of long, parameterized and detailed HTTP requests as corresponding to particular actions is often a tedious task that is made more difficult by the fact that multiple, seemingly different requests can classify the same action. Often, an administrator is forced to review and sort hundreds of requests to classify which ones relate to which actions so that the statistics related to the user actions can be developed. This process is time consuming, manpower intensive and expensive. Moreover, current systems that provide limited recognition of requests require an administrator to have detailed knowledge of the expected request structures so that the administrator can write proper search rules for identifying requests as corresponding to particular user actions. Again, this can be extremely time consuming as the administrator must be able to write search rules for requests that may contain a vast number of parameter combinations.

### SUMMARY OF THE INVENTION

Embodiments of the present invention provide systems and methods for generating rules to classify requests that substantially eliminate or reduce the disadvantages of previously developed request classification systems and methods. More particularly, embodiments of the present invention provide a set of code (e.g., a computer program product comprising a set of computer instructions stored on a computer readable medium and executable by a computer processor) comprising instructions executable to record requests directed to a server application, associate the recorded requests with transactions, and for each transaction, automatically generate identification rules for the transactions based on the content of the recorded requests to classify subsequent requests as corresponding to particular transactions. Additionally, the code can be executable to update the identification rules as new requests are recorded. For example, according to one embodiment of the present invention, a request classification program can record HTTP requests directed to a web server, associate the requests with transactions and automatically generate identification rules for the transactions so that subsequent HTTP requests can be classified according to the identification rules. The requests used in developing the identification rules can be recorded over time (for example, in multiple recording sessions) and the rules generated over time. As new requests are processed, existing identification rules can be updated.

According to one embodiment, a request associated with a transaction is examined. If the Uniform Resource Indicator (“URI”) of the requests is unique to that transaction—that is, if the URI is not used by requests associated with other transactions—an identification rule can be established for the selected transaction based on the URI so that subsequent requests containing the URI are classified as corresponding to the selected transaction. If the URI is not unique to the selected transaction, the code can generate a set of differentiating context sets for the transaction and establish an identification rule based on the URI and at least one of the differentiating context sets so that subsequent requests that contain the appropriate URI and appropriate context set are classified as corresponding to the selected transaction.

The code can be further executable to present a user with user interface that allows the user to indicate that a recording session should begin and end and the transaction with which the requests recorded in the recording session should be associated. The user interface can provide the identification rules and other information to a user.

Another embodiment of the present invention can include a method comprising receiving a set of requests, associating each request in the set of requests with a transaction from a set of transactions and automatically generating one or more identification rules for each transaction based on the content of requests associated with that transaction, wherein each request associated with each transaction meets at least one of the one or more identification rules for that transaction.

Yet another embodiment of the present invention can include a method comprising receiving a first request, associating the first request with a first transaction, automatically generating an identification rule for the first transaction based on the content of the first request, receiving a second request, associating the second request with a second transaction, automatically generating an identification rule for the second transaction and updating the identification rule for the first transaction.

Embodiments of the present invention provide a technical advantage over previously developed request classification systems and methods by providing a mechanism for automatically generating identification rules based on a small number of sample requests. Because the rules are automatically generated using sample requests, the time required to generate rules for transactions is substantially reduced. As an example, embodiments of the present invention can recognize patterns. In a small number of sample requests associated with an “Add to Carts” transaction and automatically generate an identification rule that classifies subsequent requests having one or more of the recognized patterns as corresponding to the “Add to Carts transaction.

Embodiments of the present invention provide another advantage by learning how to classify requests more accurately as more requests are processed. Over time, embodiments of the present invention can learn patterns and usage of requests to classify particular requests better.

Embodiments of the present invention provide another advantage by simplifying the pre-production process of creating a web site. For example, embodiments of the present invention can provide a simply GUI that does not require the user to have detailed knowledge about request structure to generate identification rules.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 is a diagrammatic representation of an example system in which embodiments of the present invention can be implemented;

FIG. 2 is a flow chart illustrating one embodiment of a method for generating identification rules for a request;

FIG. 3 is a flow chart illustrating one embodiment of a method for a graphical user interface (“GUI”);

FIG. 4 is a flow chart illustrating one embodiment of processing a request to generate an identification rule;

FIGS. 5a-p are diagrammatic representations of content that can be displayed by a browser including an example embodiment of a GUI; and

FIG. 6 is a diagrammatic representation of an example computing device that can execute a request classification program.

### DETAILED DESCRIPTION OF THE INVENTION

Preferred embodiments of the present invention are illustrated in the FIGUREs, like numerals being used to refer to like and corresponding parts of the various drawings.

A “transaction”, for purposes of this disclosure, is a defined class to which a request corresponds. Broadly speaking, embodiments of the present invention generate identification rules to classify requests as corresponding to particular transactions. Embodiments of the present invention examine a set of sample requests, determine patterns in the sample requests and generate identification rules based on the request patterns to classify subsequent requests as corresponding to particular transactions. As more sample requests are processed, embodiments of the present invention can update the identification rules. Put another way, embodiments of the present invention can automatically learn how to classify requests more accurately as more requests are processed.

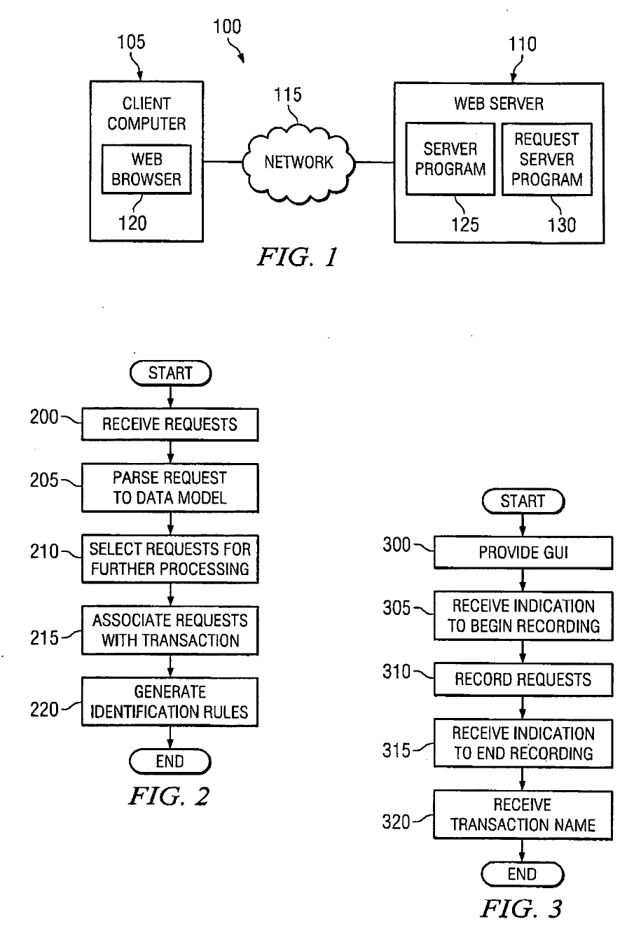

FIG. 1 is a diagrammatic representation of one embodiment of a system in which embodiments of the present invention can be implemented. System 100 includes a client computer 105 that can connect to a web server 110 (or servers) via a network 115 (e.g., a LAN, WAN, wireless network, global communications network, or other network known in the art). Client computer 105 can include a web browser program 120 and web server 110 can include a web server program 125 and a request classification program 130. Client computer 105 and web server 110 can include any suitable computer components including processors, memories, network adapters and so on. Web browser program 120 generates requests to web server program 125 for content corresponding to a particular uniform resource identifier (“URI”), which may be or include a uniform resource locator (“URL”), and displays the returned content (or a portion of the returned content) In a graphical user interface (“GUI”). A user can use the GUI to take further actions to generate additional requests to web server program 125. Web server program 125 returns content in response to the requests made by web browser program 120. Request classification program 130, as discussed below, records requests to web server program 125 and develops rules for classifying requests as corresponding to particular transactions.

Although shown as a separate program from web server program 125, request classification program 130 can be implemented as any suitable set of code such as a module of another program (e.g., web server program 125, web browser program 120), a standalone program or according to any other suitable software architecture. Request classification program 130 can be implemented at any point that allows request classification program 130 to record requests sent by web browser program 120 to web server program 125. For example, request classification program 130 can be implemented at a proxy server, client computer 105 or other suitable location that allows request classification program 130 to record requests to web server program 125. According to other embodiments, web browser program 120, web server program 125 or other component can be configured to forward copies of requests to request classification program 130. Additionally, while embodiments of the present invention are primarily discussed in the context of requests from a web browser to a web server, this is for the sake of example, but not limitation. Embodiments of the present invention can record any number of different types of requests from a variety of clients to a variety of recipients.

In operation, a user can take an action using web browser program 120 to cause web browser program 120 to generate requests to web server program 125. For example, the user can perform an action such as selecting to view an item in a web page, add an item to a virtual shopping cart, purchase an item, submit a form or perform some other action. Request classification program 130 records the resulting requests. Using request classification program 130, the user can associate the requests generated by the action with a transaction of interest. For example, the user may associate the requests generated by selecting to view an item with a “View Item” transaction. Using the requests associated with the transaction and potentially other transactions, request classification program 130 can develop identification rules for determining if subsequent requests correspond to that transaction. Using the foregoing example, request classification program 130 can automatically develop rules for classifying subsequent requests as corresponding to the defined View Item transaction. As new requests are associated with a particular transaction or other transactions, the identification rules can be updated.

FIG. 2 is a flow chart illustrating one embodiment of a method for classifying requests. The steps of FIG. 2 can be implemented as a set of computer instructions, for example request classification program 130, stored on a computer readable medium and executable by a processor. At step 200, request classification program 130 receives a set of requests corresponding to a user action. Generally, a request includes a URI and context Information. The context information can be included, for example, in headers, query strings, a request's body (e.g., POST data, XML data, other data) or other portion of the request. In the example of a request to a web server, the request is usually an HTTP request, which may have different formats and structures. There are standard HTML/DHTML requests, XML based requests such as SOAP, binary request such as in the case of FLEX (AMF Remoting) and requests according to a variety of other standard and proprietary formats. To make analysis of the requests more efficient, request classification program, at step 205, can parse each request to map the request to a common data model. According to one embodiment, the common data format is defined by the URI and a set of contexts (name/value pairs). For an HTTP request, the URL is the URI and the contexts are other parameters Included in the request. As an example, for the request http://tlvs2k292:9080/PlantsbyWebSphere/Sevlet/ShoppingServlet?action=shopping&catagory=2, the URL is http://tlvs2K292:9080/PlantsbyWebShpre/Servlet/ShoppingServlet and the contexts are action=shopping and category=2. For non-standard formatting, the user can configure request classification program 130 to recognize delimiters between name/value pairs and plug-ins can be provided to update the parsing to account for new or proprietary request formats.

Request classification program 130, at step 210, can select certain requests for further processing (i.e., can filter out non-selected requests). This can be useful, but not necessary, because a user action in a web page may cause some requests to be generated that do not provide information of interest in determining which actions a user takes. For example, in addition to the above request, a user action in a web page can generate .gif, .jpg., .js requests or other requests for static or dynamic content. In some cases, requests for static content are not of interest as they can be generated for a great many diverse user actions. Moreover, in many websites, there is little guarantee that similar requests will be made the next time the same user action is performed (e.g., a JSP page can load different pictures each time it is loaded). Therefore, request classification program 130 can optionally filter out requests for various types of content, such as requests for static data, .js content and other predefined content.

At step 215, request classification program 130 associates each of the selected requests with a transaction. Each of the requests can be associated with the same transaction or with different transactions. For example, two requests can be associated with a user defined transaction, one request can be associated with the user defined transaction and the other with the a system defined transaction (such as a crosscut transaction, discussed below), two requests associated with the same or different system defined transactions and so on. At step 220, request classification program can automatically generate identification rules for a transaction based on requests associated with that transaction and requests associated with other transactions. According to one embodiment, all the requests associated with a transaction meet an identification rule for that transaction but not an identification rule for another transaction. The identification rule(s) for a transaction can be used to identify subsequent requests as corresponding to that transaction. The steps of FIG. 2 can be repeated as needed or desired. Additionally, various steps can be performed in different orders or skipped and additional steps added.

The steps of receiving (step 200) requests and associating requests with a transaction (step 215) can be facilitated through the use of a GUI. FIG. 3 is a flow chart of one embodiment of a method for utilizing a GUI to facilitate the generation of identification rules. The steps of FIG. 3 can be implemented as a set of computer instructions, for example request classification program 130, stored on a computer readable medium and executable by a processor. Request classification program 130, at step 300, can present a GUI to a user that allows the user to indicate that request classification program 130 should start and stop monitoring requests and allows the user to define transactions. At step 305, the request classification program 130 can receive an indication that the user wishes to begin a recording session. Request classification program 130, at step 310, records requests until it receives an indication that the user wishes to end the recording session at step 315. At step 320, request classification program 130 can receive a transaction name entered by the user through the GUI and associate one more of the recorded requests from the recording session with the transaction. The steps of FIG. 3 can be repeated as needed or desired. Additionally, various steps can be performed in different orders or skipped and additional steps added.

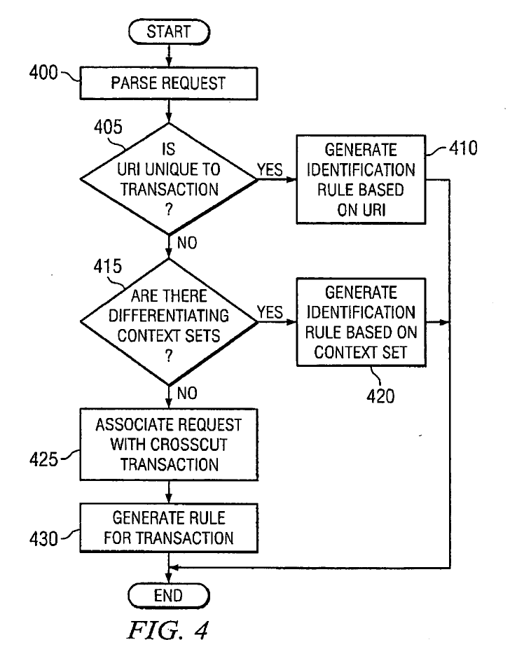

Request classification program 130 can process the recorded requests (or some subset thereof) to generate identification rules. FIG. 4 is flow chart illustrating one embodiment of a method for generating identification rules for requests. The steps of FIG. 4 can be implemented as a set of computer instructions, for example request classification program 130, stored on a computer readable medium and executable by a processor. At step 400, request classification program 130 parses a request for a transaction to determine the URI and context sets (name/value pairs) for the request. Request classification program 130, at step 405, compares the URI of the request to the URIs of requests associated with other transactions. If there are no other transactions with requests having the same URI, the URI itself can be used for the identification rule (step 410).

As an example, assume a user associates the request http://tlvs2k292:9080/PlantsbyWebSphere/Sevlet/ShoppingServlet?action=shopping&catagory=2 with a “Trees” transaction and the request http://tlvs2k292:9080/PlantsbyWebSphere/Sevlet/CheckoutServlet?action=shopping&catagory=2 with an “Add to Cart” transaction and that Trees and Add to Cart are the first transactions defined. When request classification program 130 analyzes the requests, it can compare the URLs. In this case, because the URLs are different and not used by requests associated with other transactions, request classification program 130 can generate a rule that any request with the URL http://tlvs2k292:9080/PlantsbyWebSphere/Sevlet/ShoppingServlet is a Trees transaction and any request with the URL http://tlvs2k292:9080/PlantsbyWebSphere/Sevlet/CheckoutServlet is an Add To Cart transaction. However, as discussed below, these rules can change as new transactions and requests are processed.

If the URL of a request is not unique to the transaction, request classification program 130, at step 415, compares the context sets of the request to the context sets of requests associated with other transactions to determine the context set or sets of the request being analyzed that differentiate it from the requests of other transactions having the same URI. According to one embodiment, the context sets of the query portion of the request can be analyzed first and if there are no differentiating context sets based on the query portion, the body portion of the request can be analyzed. At step 420, request classification program 130 can generate identification rules for a transaction using the differentiating context sets of the request that appear in all requests associated with the same transaction.

To provide an example, let S₁ and S₂ denote sets of contexts for two requests and S₁={C1_{S1}, C2_{S1}, . . . CM_{S1}} for M contexts and S₂={C1_{S2}, C2_{S2}, . . . CN_{S2}} for N contexts. The intersection between two context sets is defined by:

S₁∩S₂={C1_{S1∩S2}, . . . , CK_{S1∩S2}}

[symbol]

∀(CL_{S1∩S2})1≦L≦K

∃(CJ_{S1})εS₁CJ_{S1}=CL_{S1∩S2}

∃(CY_{S2})εS₂CY_{S1}=CL_{S1∩S2}

Where a context C may be a [name=value] pair or just a [name].

According to one embodiment, request classification program 130 can work in two phases to generate rules based on context sets. For each defined transaction, request classification program 130 analyzes requests associated with the transaction (or some subset of requests) and finds all the context subsets Dₖ that differentiate it from the context sets for other transactions. If T_{i,j} denotes a transaction i defined in request classification program 130 of instance j (an instance is a recorded set of data of a request), then:

∀_{i,n,m,p}∀_{k≠l}S_{k,n}⊂T_{k,m}S_{k,n}⊂/T_{i,p} [symbol] S_{k,n}εDₖ

In the second phase, request classification program 130 can select a minimal or maximal default context subset from Dₖ that is also a subset of the requests for the transaction according to:

∀_{i,k}SᵢεDₖ|Sᵢ|ₘᵢₙSₗ⊂∩ⱼT_{k,j}

To put of the above embodiment of analyzing context sets In terms of analyzing example requests, recall that the user in the previous examples defined the transactions Trees and Add to Cart. Now assume the user defines a “Flowers” transaction and associates the request http://tlvs2k292:9080/PlantsbyWebSphere/Sevlet/ShoppingServlet?action=shopping&catagory=0 with the flowers request. Further assume the user defines a “View Item” transaction and associates the following requests with the View Item Transaction: http://tlvs2k292:9080/PlantsbyWebSphere/Sevlet/ShoppingServlet?action=ProductDetail &itemID=0010 and http://tlvs2k292:9080/PlantsbyWebSphere/Sevlet/ShoppingServlet?action=ProductDetail &itemID=0015. Table 1 summarizes the sample defined transactions and the associated requests.

TABLE 1

| Transaction Name | Requests |
|---|---|
| Trees | http://tlvs2k292:9080/PlantsbyWebSphere/Sevlet/ShoppingServlet?action=shopping&catagory=2 |
| Flowers | http://tlvs2k292:9080/PlantsbyWebSphere/Sevlet/ShoppingServlet?action=shopping&catagory=0 |
| View Item | http://tlvs2k292:9080/PlantsbyWebSphere/Sevlet/ShoppingServlet?action=ProductDetail&itemID=0010 |
| | http://tlvs2k292:9080/PlantsbyWebSphere/Sevlet/ShoppingServlet?action=ProductDetail&itemID=0015 |
| Add to Cart | http://tlvs2k292:9080/PlantsbyWebSphere/Sevlet/CheckoutServlet?action=shopping&catagory=2 |

When request classification program 130 reviews the requests of Table 1, it can determine that while the URL of the request associated with Add to Cart is unique to that transaction, the URL of the request associated with Trees is no longer unique to that transaction and is shared by requests associated with the Flowers and View Item transactions. The identification rule for Trees should now be updated while the rule for Add to Carts can remain unmodified.

As discussed above, request classification program 130 can analyze the context sets for each request to determine the context sets associated with a transaction that differentiate that transaction from other transactions. Table 2 below provides the differentiating context sets that differentiate each of the Trees, Flowers and View Items transactions from each other based on the requests of Table 1.

TABLE 2

| Transaction Name | Context Sets from Requests |
|---|---|
| Trees | { category=2} |
| | {action=shopping, category=2} |
| Flowers | {category=0} |
| | {action=shopping, category=0} |
| View Item | {action=ProductDetail} |
| | {itemID=0010} |
| | {itemID=0015} |
| | {action=Product Detail, itemID=0010} |
| | {action=Product Detail, itemID=0015} |

From the knowledge available to request classification program 130, the example context sets provided in Table 2 only appear in requests associated with the corresponding transaction and can thus be used to formulate identification rules for that transaction. Request classification program 130 can automatically select a context set on which to base an identification rule or allow a user to select a context set. As example, request classification program can select the context set (category=2) as part of the identification rules for Trees and the context set {category=0} part of the identification rules for Flowers. Consequently, the identification rule for the Trees transaction can be updated so that any requests having the URL http://tlvs2k292:9080/PlantsbyWebSphere/Sevlet/ShoppingServlet and the context set category=2 will be classified as corresponding to a Trees transaction and any requests having the URL http://tlvs2k292:9080/PlantsbyWebSphere/Sevlet/ShoppingServlet and the context set (category=0) will be classified as corresponding to the Flowers transaction. While, in this example, the smallest context set is selected for each transaction, any context set can be selected for the Identification rule.

For the View Item transaction, request classification program 130 can review the differentiating context sets for that transaction and select a context set that is a subset of all the differentiating context sets for the View Item transaction. Using the example of Table 2, only the context set {action=ProductDetail} is a subset of the other differentiating context sets for the same transaction and therefore can be selected as part of the identification rule for the View Item transaction. In this case, request classification program 130 can generate an identification rule that any request that includes the URL http://tlvs2k292:9080/PlantsbyWebSphere/Sevlet/ShoppingServlet and the context set {action=ProductDetail} should be classified as a View Item transaction. When more than one differentiating context set is a subset of all the differentiating context subsets for a transaction, classification program 130 can automatically select a context subset or allow a user to select the context subset.

If a particular request can not be differentiated from a request associated with another transaction, request classification program can associate the request with a system generated transaction (step 425) and generate one or more identification rules for the transaction as discussed above (step 430). On example of a system generated transaction is referred to as a “crosscut transaction” as the requests associated with the crosscut transaction are generated for a number of user actions. Examples of such requests are requests for security validations, collections of statistical data or requests to image servers.

A crosscut transaction is generated for a request in a recording (step 310) only if there is at least one other request in the recoding for which an identification rule was generated successfully. If no identification rules were generated for any of the requests in the recording an error message may be displayed to the user with suggestions on how to proceed. There are at least two possible failure reasons. A first example reason for a failure to generate an identification rule is that none of the requests can be differentiated from requests associated to other transactions; in this case the user may be advised to merge the conflicting transactions into one transaction or ignore the conflict and thus create two identification rules that will apply to the same requests but the less generic one will be selected later on in the classification process. The second reason for failure is that none of the requests in the recording have any common ground with request associated with the same transaction from previous recordings; in this case the user may be advised to associate the last recording with a different transaction name.

Over time, as more requests are analyzed, request classification program 130 will have a broader baseline for classification and can implement algorithms to extrapolate rules from repetitive request patterns. For example, if request classification program 130 sees various results for requests associated with the same transaction having parameter P=2, P=6, request classification program 130 can extrapolate the P=x, where x is variable, corresponds to the same transaction. Moreover, as more transactions are processed, user intervention is minimized.

As can be understood from the foregoing, request classification program 130 can learn how to classify requests as corresponding to a transaction as requests are processed. That is, request classification program 130 can update identification rules as more requests are processed. Additionally, request classification program can learn how to classify seemingly different requests (e.g., a request to view Lilies (productID 0010) and a request to view Red Roses (productID 0015)) as corresponding to the same transaction. The identification rules can then be used by performance monitoring applications to measure statistics and the performance of the system in terms of the defined transactions. The steps of FIG. 4 can be repeated as needed or desired. Additionally, various steps can be performed in different orders or skipped and additional steps added.

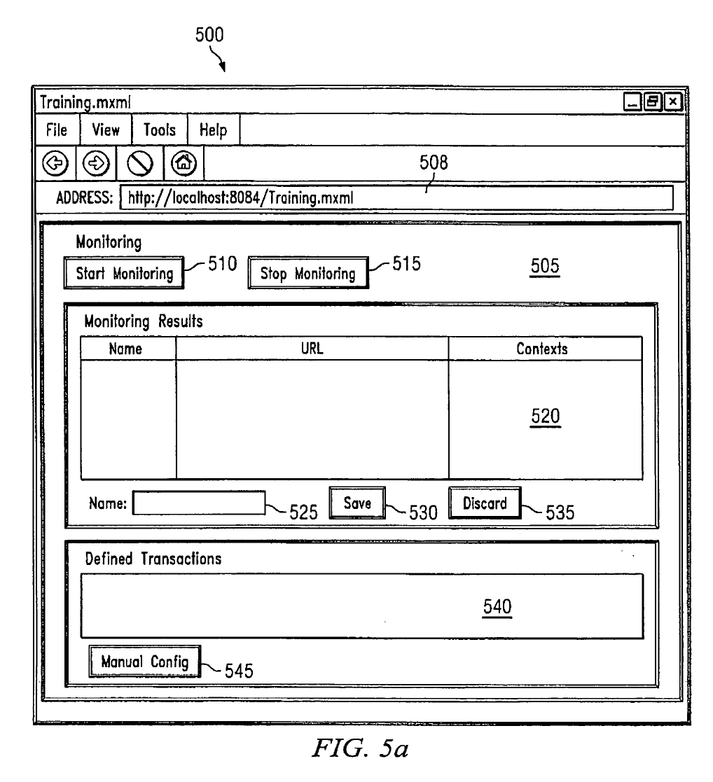

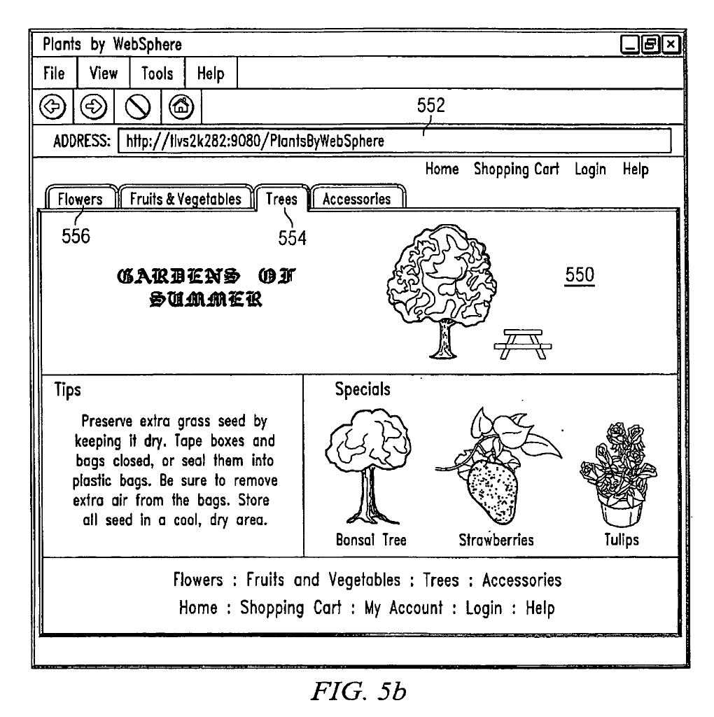

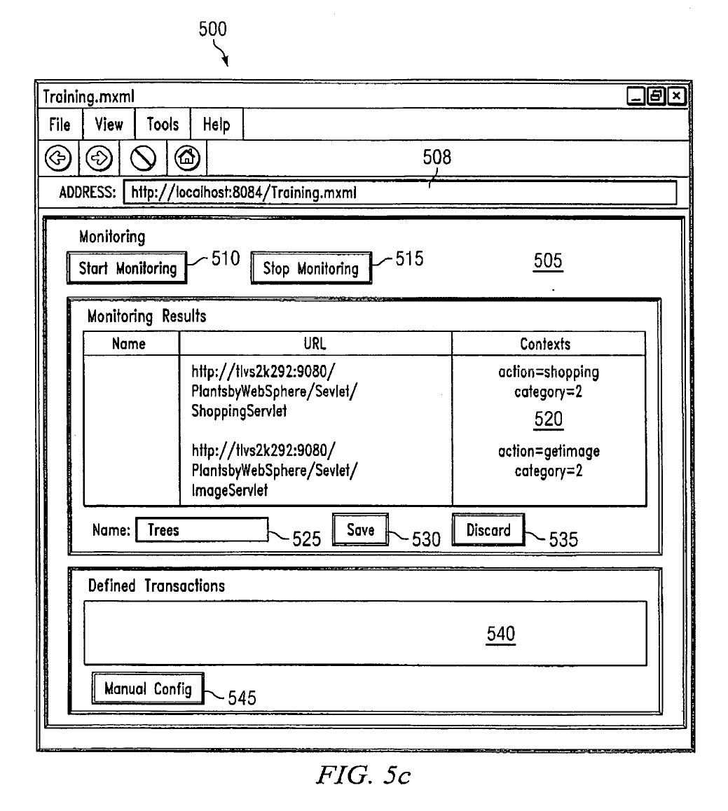

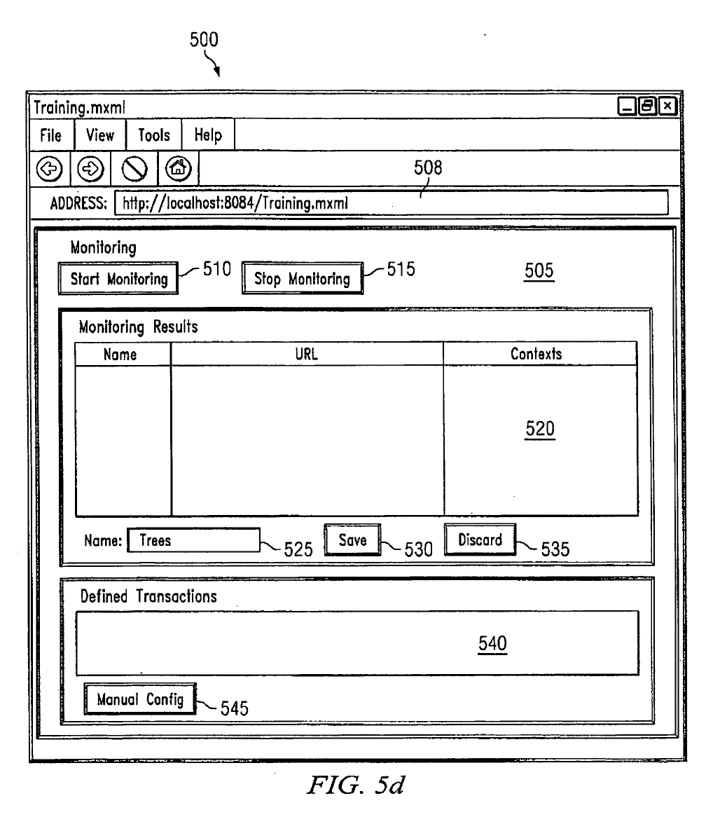

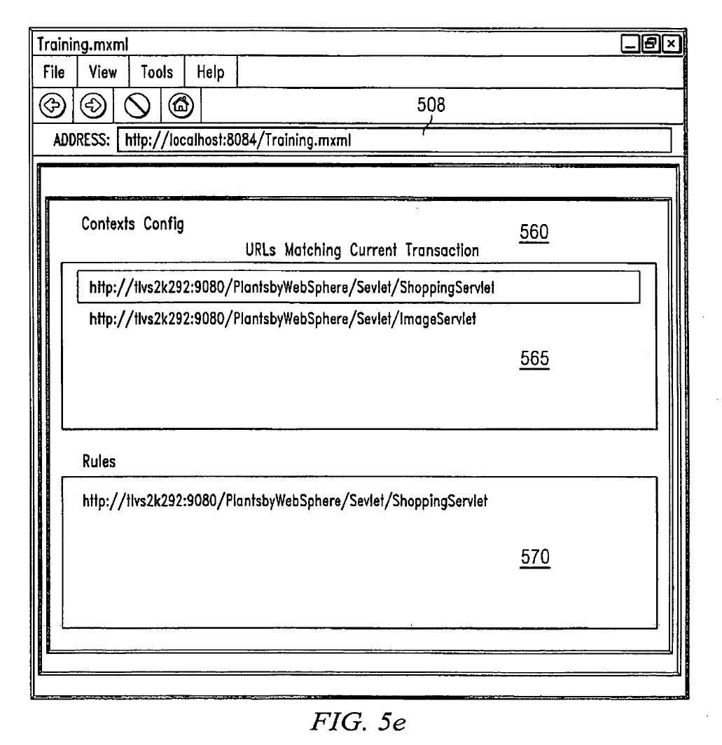

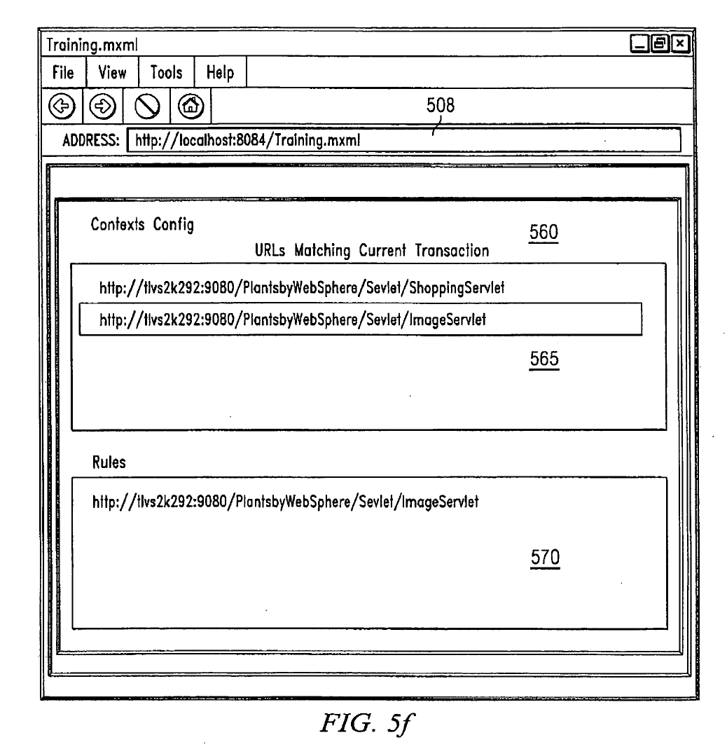

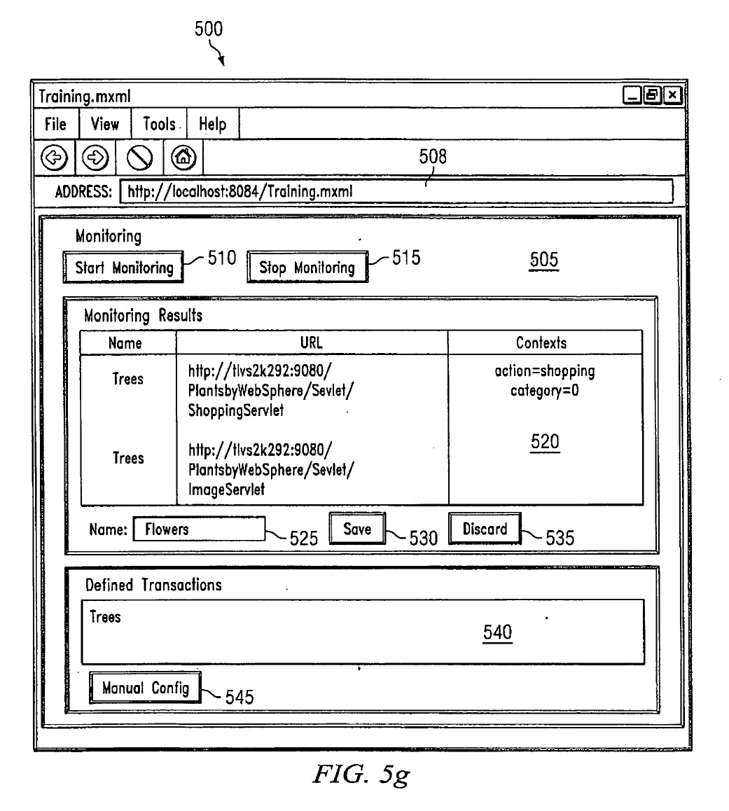

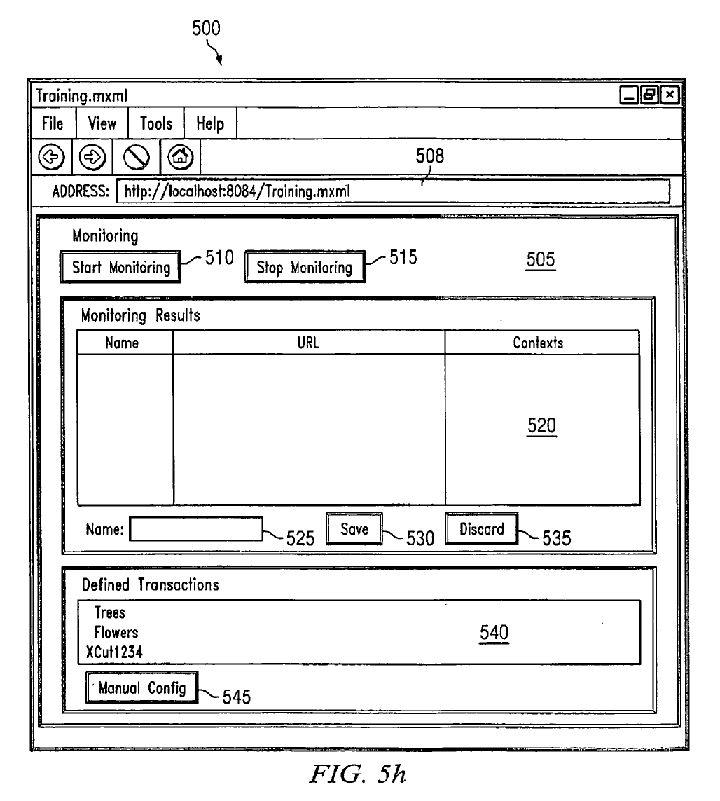

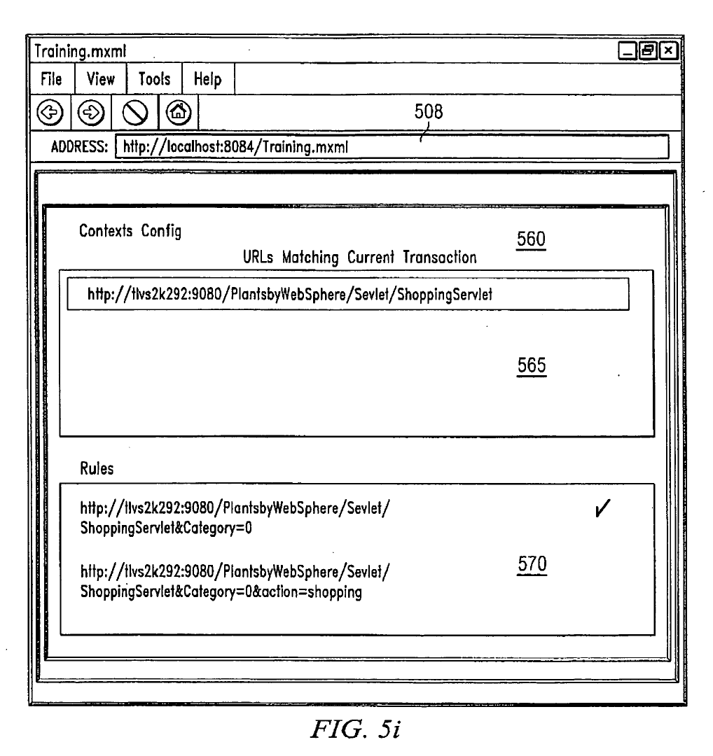

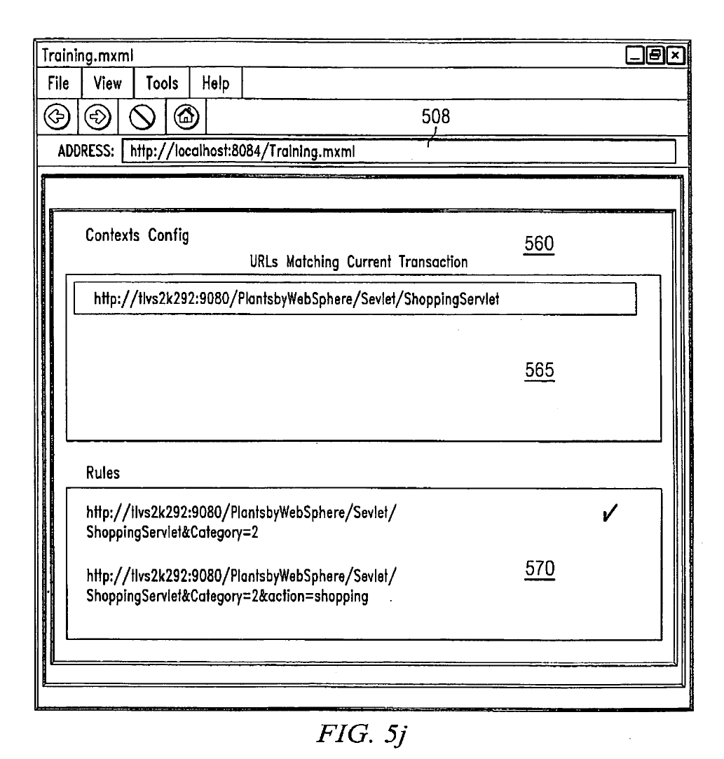

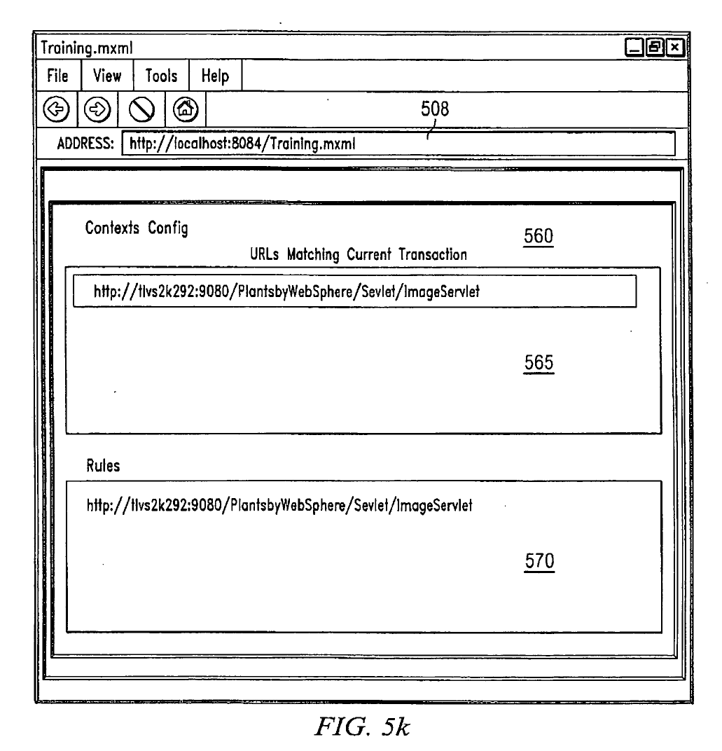

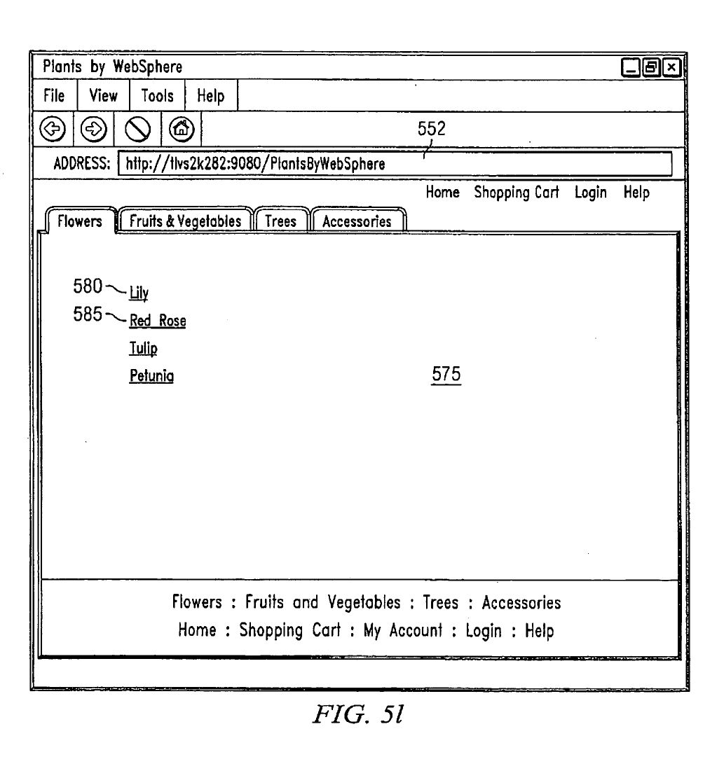

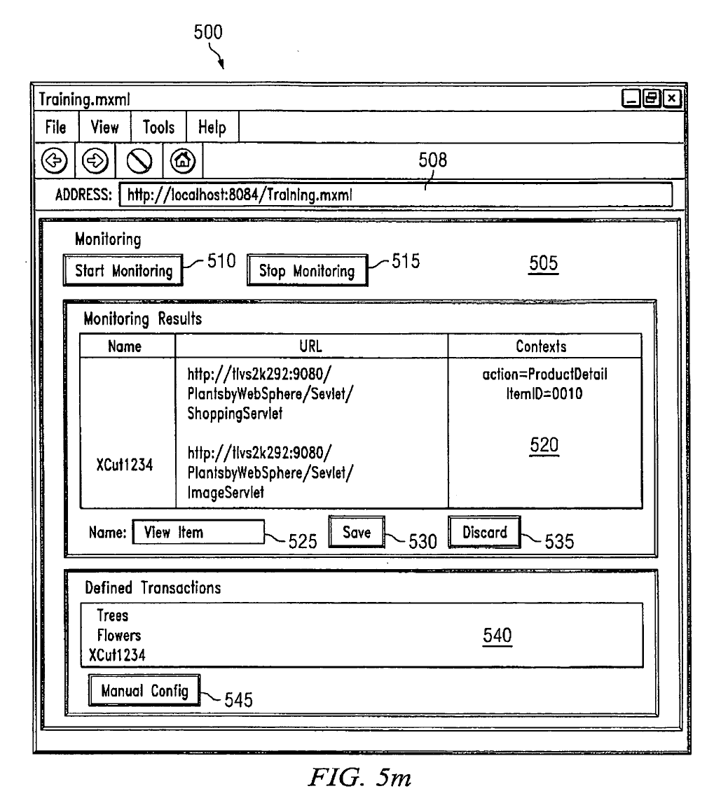

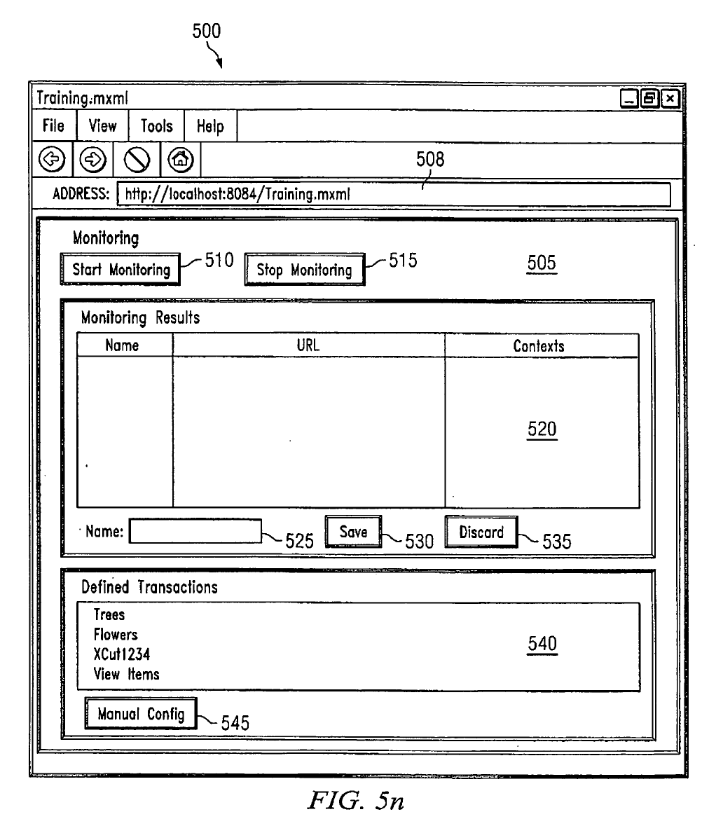

As discussed above, embodiments of the present invention can provide a simple GUI to allow a user to define transactions and associate requests with transactions. According to one embodiment, the GUI of request classification program 130 can be accessed using web browser program 120. FIG. 5a is a diagrammatic representation of a screen 500 displaying a monitoring page 505 for request classification program 130. In this example, the GUI is invoked when the user directs the web browser to the address http://localhost:8084/training.mxml (as shown in address bar 508). According to the embodiment shown in FIG. 5a, monitoring page 505 includes a “Start Monitoring” button 510 to begin a recording session, a “Stop Monitoring” button 515 to end the recording session, a request display area 520 to display recorded requests, a transaction name box 525 to name a transaction, a “save” button 530 to save a transaction, a discard button 535 to discard a transaction, a defined transactions display area 540 and a manual configuration button 545 to allow a user to manually configure transactions and view details of transactions. The operation of the GUI will be discussed in conjunction with navigating an example web site.

Turning briefly to FIG. 5b, an example web page 550 is illustrated. As shown in address bar 552, the example web page corresponds to the URL http://tlvs2k292:9080/PlantsbyWebSphere. The web page, in this example, is a web page for a garden center (nursery) that allows users to view and purchase various Items. Of interest for the following examples are “Trees” tab 554 that causes browser program 120 to send requests for content regarding trees and “Flowers” tab 556 that causes browser program 120 to send requests for content regarding flowers. Web page 550 can be displayed by a different instance of web browser program 120 than monitoring page 505 of FIG. 5a, in a different window provided by web browser program 120, in a different tab of web browser program 120 (if web browser program 120 allows tabbed browsing) or in another manner that allows the user to easily switch back and forth from web page 550 (or other displayed web page) and the GUI of request classification program 130.

Returning to FIG. 5a, the user can begin a recording session by clicking on Start Monitoring button 510. This will cause request classification program 130 to begin monitoring requests to web server program 125. The user can then switch to web page 550 of FIG. 5b and perform a user action. For example, the user can click on Trees tab 554. The user can then switch back to the GUI of request classification program 130 and click on Stop Monitoring button 515, causing request classification program 130 to stop the recording session. For the sake of example, assume that the user action caused the following two requests to be generated: http://tlvs2k292:9080/PlantsbyWebSphere/Sevlet/ShoppingServlet?action=shopping&catagory=2 and http://tlvs2k292:9080/PlantsbyWebSphere/Sevlet/ImageServlet. FIG. 5c illustrates monitoring page 505 with these requests displayed after the user has clicked on the Stop Monitoring button 515.

The user can associate these requests with a transaction by entering a transaction name in transaction name box 525 and selecting save button 530. In this example, the user has selected to define a transaction “Trees”. FIG. 5d illustrates the saved Trees transaction in defined transactions box 540. The user can select the defined Trees transaction and select manual configuration button 545 to see more information about the Trees transaction.

FIGS. 5e and 5f are diagrammatic representations of web browser program 120 displaying a configuration page 560 displayed when the user selects configuration button 545. According to the illustrated embodiment, configuration page 560 includes a URL box 565 displaying URLs for requests associated with a selected transaction (in this example, the Trees transaction) and a rules box 570 displaying rules for the selected transaction. For the Trees transaction URL box 565 displays the URLs http://tlvs2k292:9080/PlantsbyWebSphere/Sevlet/ShoppingServlet and http://tlvs2k292:9080/PlantsbyWebSphere/Sevlet/ImageServlet, corresponding the requests of the Trees transaction. The user can select a URL to display rules associated with that URL for the transaction. In the example of FIG. 5e, the user selects the http://tlvs2k292:9080/PlantsbyWebSphere/Sevlet/ShoppingServlet. The rule displayed in rules box 570 indicates that any request having the URL http://tlvs2k292:9080/PlantsbyWebSphere/Sevlet/ShoppingServlet will correspond to a Trees transaction. In the example of FIG. 5f, the user selects the http://tlvs2k292:9080/PlantsbyWebSphere/Sevlet/ImageServlet URL. Rules box 570 indicates that any request with the URL http://tlvs2k292:9080/PlantsbyWebSphere/Sevlet/ImageServlet will also correspond to a Trees transaction. As discussed below, however, request classification program 130 can automatically update these rules as the user defines new transactions.

To illustrate updating of the rules, assume the user wishes to define a Flowers transaction. The user can return the browser to web page 550 (shown in FIG. 5b) and monitoring page 505 of request classification program 130 (shown in FIG. 5d). The user can select start monitoring button 510 to begin a recording session, switch to web page 550, select Flowers tab 556, switch back to monitoring page 505 and select stop monitoring button 515 to stop the recording session. In this example, web browser program 120 generates the requests http://tlvs2k292:9080/PlantsbyWebSphere/Sevlet/ShoppingServlet?action=shopping&catagory=0 and http://tlvs2k292:9080/PlantsbyWebSphere/Sevlet/ImageServlet.

FIG. 5g is a diagrammatic representation of an example GUI for request classification program 130 after the user has selected stop monitoring button 515. The results of the recording session are displayed in request display area 520.

It can be noted from FIG. 5g, that request classification program has classified both of these requests as corresponding to the Trees transaction because both transactions fit the identification rules for the Trees transaction. However, the user can associate the requests with a different transaction by entering a new transaction name in transaction name box 525 and selecting save button 530. For the example, the user can enter Flowers In transaction name box 525 and select Save button 530 to define a Flowers transaction.

FIG. 5h illustrates the example results of a user defining the Flowers transaction. As can be seen in defined transactions box 540 the user-defined transactions of Trees and Flowers appear. Additionally, a system transaction of XCut1234 appears. In this case, because the request http://tlvs2k292:9080/PlantsbyWebSphere/Sevlet/ImageServlet was associated with both the Trees transaction and the Flowers transaction, request classification program can reclassify the request as a crosscut transaction because the request appears in more than one transaction.

As discussed above, the user can select a transaction and click on manual configuration button 545 to learn more information about the defined transactions. FIG. 5i illustrates an example of configuration page 550 showing information for the Flowers transaction. In this example, the URL displayed in URL display box 565 is http://tlvs2k292:9080/PlantsbyWebSphere/Sevlet/ShoppingServlet. However, as this is the same URL used for the Trees transaction (as shown in FIG. 5e), request classification program 130 can also use the context sets of the request to generate Identification rules. As shown in rules box 570, two possible rules are displayed. In addition to the URL, the first rule requires the context set {category=0} and the second rule requires the context set {category=0, action=shopping}. According to one embodiment, the first rule can be selected for classifying requests as belonging the Flowers transaction as it requires less context sets to match the rule. The user can optionally select the other rule.

FIG. 5j illustrates an example of configuration page 560 showing updated information for the Trees transaction after the Flowers transaction is added. Comparing FIGS. 5j to 5e, the URL http://tlvs2k292:9080/PlantsbyWebSphere/Sevlet/ImageServlet no longer appears in URL display box 565 for the Trees transaction as it has be reclassified as a crosscut transaction. Moreover, rules box 570 displays updated rules for the Trees transaction because the URL http://tlvs2k292:9080/PlantsbyWebSphere/Sevlet/ShoppingServlet is no longer unique to the Trees transaction. In this example, the two rules for the Trees transaction respectively require the context set {category=2} and the context set (category=2, action=shopping). Thus, based on the addition of the Flowers transaction, the identification rule for the trees transaction has been updated.

FIG. 5k illustrates an example of configuration page 560 showing information for the XCut1234 transaction. In this case, the URL for the XCut1234 transaction is http://tlvs2k292:9080/PlantsbyWebSphere/Sevlet/ImageServlet as shown by URL display box 565. The identification rule, as displayed in rule box 570, wilt classify any request having the URL http://tlvs2k292:9080/PlantsbyWebSphere/Sevlet/ImageServlet as corresponding to a XCut1234 transaction. The user can be given the option to rename system generated transactions to a more user-friendly format. For example, the user may wish to rename XCut1234 “Fetch Images” or some other name.

Continuing with the example of the user navigating a web site to provide sample requests, recall that before the user defined the “Flowers” transaction, the user clicked on Flowers tab 556 of web page 550 (shown in FIG. 5b). FIG. 51 is a diagrammatic representation of an example of a web page 575 that can be displayed by web browser program 120 from content returned by web server program 125 in response to the requests sent by web browser program 120 when the user clicked on Flowers tab 556. Web page 575 is a “Flowers” page that includes links to content about specific flowers. For example, link 580 links to content about lilies and link 585 links to content about roses. Now assume the user wishes to group requests generated by the user action of selecting to view individual flowers as a View Items transaction. The user can switch to monitoring page 505 (shown in FIG. 5h), select Start Monitoring button 510, switch to viewing web page 575, select link 580 to view content on lilies, switch back to monitoring page 505 and select Stop Monitoring button 510 to end the recording session. Example results of the recording session are shown in FIG. 5m.

FIG. 5m is a diagrammatic representation of one embodiment of the GUI for request classification program 130 displaying requests corresponding to the user action of clicking on link 580. As can be noted from FIG. 5n in request display box 520, the request to http://tlvs2k292:9080/PlantsbyWebSphere/Sevlet/ImageServlet is classified as an XCut1234 transaction but the request to http://tlvs2k292:9080/PlantsbyWebSphere/Sevlet/ShoppingServlet is not classified because it does not fit any of the identification rules for the existing transactions. The user can choose to define a new View Item transaction by entering View Item in transaction name box 525 and selecting Save button 530. FIG. 5n is a diagrammatic representation of one embodiment of the GUI for request classification program 130 displaying the View Item transaction in defined transaction box 540. FIG. 5o is a diagrammatic representation of one embodiment of the GUI for request classification program 130 displaying the configuration information for the View Item transaction. As shown in rules box 570, the identification rule for the View Item transaction requires a request to the URL http://tlvs2k292:9080/PlantsbyWebSphere/Sevlet/ShoppingServlet with the context set of {action=ProductDetail}.

Now assume the user wishes to associate another user action with the existing “View Item” transaction. The user can, for example, switch back viewing web page 575 with web browser program 120, switch to configuration page 505 of the GUI of request classification program 130 (shown in FIG. 5n), select Start Monitoring button 510, switch to viewing web page 575, select link 585, switch back to viewing configuration page 505 and select stop monitoring button 515 to end the recording session. FIG. 5p is a diagrammatic representation of one embodiment of the GUI for request classification program 130 displaying requests corresponding to the user action of clicking on link 580. As can be seen in FIG. 5p, the rule established for View Item (shown in FIG. 5o) classifies the request http://tlvs2k292:9080/PlantsbyWebSphere/Sevlet/ShoppingServlet&action=ProductDetail &ItemID=0015 as being a View Items transaction. Thus, the existing View Items identification rule is sufficient to identify this request as corresponding to the View Items transaction.

In the above examples, request classification program 130 generates identification rules such that a particular request will correspond to a particular transaction. According to another embodiment, the user can define rules for transactions such that a request will be classified under two transactions. For example, the user can define an additional transaction View Roses such that a request generated when the user clicks on link 585 Will be classified as both a View Item transaction or a View Roses transaction.

In the above examples, embodiments of the present invention automatically generate identification rules to classify HTTP requests as corresponding to particular transactions based on sample requests a user associates with the transactions. Embodiments of the present invention, however, can be applied to any number of different types of requests (e.g., FTP requests, proprietary requests and other requests). Additionally, while the user interface described above is a GUI for a human user, the user interface can provide functionality for other users, such as an automated web browsing program or other automated system.

Request classification program 130 can act in concert with or provide identification rules to performance monitoring software so that performance monitoring software can monitor system performance with respect to transaction. For example, the monitoring software can determine how long it takes a system (e.g., web server, application servers, etc.) to respond to a Trees transaction. If a request in the monitoring environment is encountered that does not fit an identification rule or is not recognized for some reason (e.g., contains a parameter that can not be parsed), request classification program, the monitoring program or other program can generate an alert so that a user can determine whether to update the identification rules.

Embodiments of the present invention provide advantages over previous systems that require a user with in-depth knowledge of request structure to manually review requests and assign requests to transactions. In previous systems, it could take a matter of weeks to program a system to classify requests for only ten transactions. Embodiments of the present invention can greatly reduce this time. Updates to the identification rules provide even greater gains in efficiency as embodiments of present invention automatically learn how to classify requests as more requests are analyzed. Embodiments of the present invention provide another advantage by simplifying pre-production of web sites by providing a simple GUI that automatically presents recommended rules to a user without requiring the user to understand in-depth the requests that generated the rules. Unlike some previous systems for example, the user does not have to define search strings to classify requests or provide other inputs that require in-depth knowledge of the requests. Additionally, because embodiments of the present invention learn over time how to classify requests, identification rules for existing transactions can be automatically updated with minimal user input.

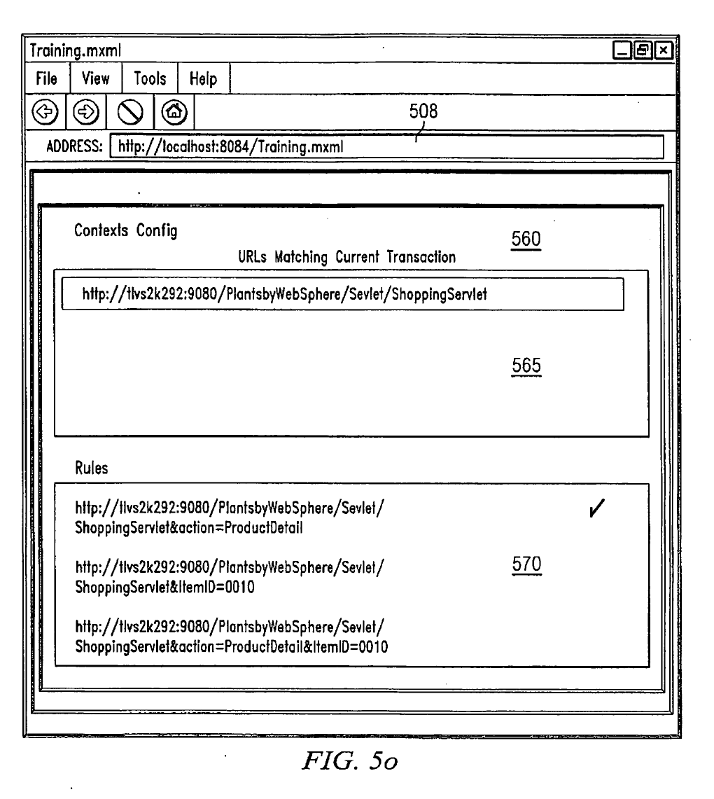

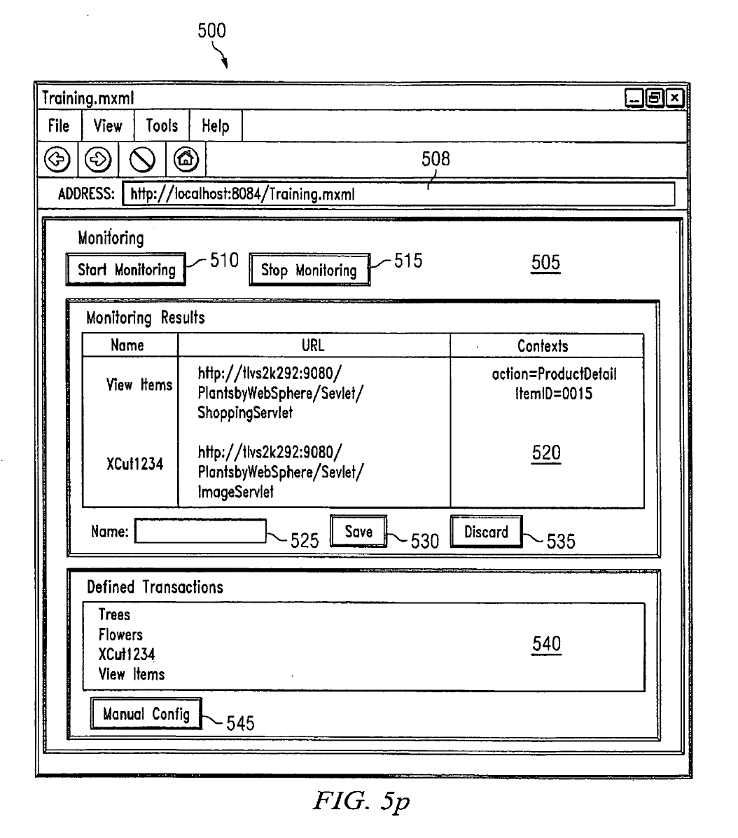

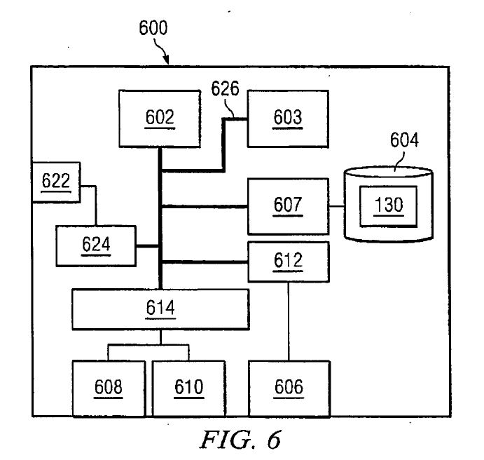

FIG. 6 provides a diagrammatic representation of one embodiment of a computing device 600. Computing device 600 can include a processor 602, such as an Intel Pentium 4 based processor (Intel and Pentium are trademarks of Intel Corporation of Santa Clara, Calif.), a primary memory 603 (e.g., RAM, ROM, Flash Memory, EEPROM or other computer readable medium known in the art) and a secondary memory 604 (e.g., a hard drive, disk drive, optical drive or other computer readable medium known in the art). A memory controller 607 can control access to secondary memory 804. Computing device 600 can include I/O interfaces, such as video interface 606 and universal serial bus (“USB”) interfaces 608 and 610 to connect to input and output devices. A video controller 612 can control interactions over the video interface 606 and a USB controller 614 can control interactions via USB interfaces 608 and 610. Computing device 600 can include a variety of input devices such as a keyboard and a mouse and output devices such as display devices. Computing device 600 can further include a network interface 622 (e.g., an Ethernet port or other network interface) and a network controller 624 to control the flow of data over network interface 622. Various components of computing device 600 can be connected by a bus 626.

Secondary memory 604 can store a variety of computer instructions that include, for example, an operating system such as a Windows operating system (Windows is a trademark of Redmond, Wash. based Microsoft Corporation) and applications that run on the operating system, along with a variety of data. More particularly, secondary memory 604 can store request classification program 130. During execution by processor 602, portions of request classification program 130 can be stored in secondary memory 604 and/or primary memory 603.

Computing device 600 of FIG. 6 is provided by way of example only and it should be understood that embodiments of the present invention can implemented as a set of computer instructions stored on a computer readable medium in a variety of computing devices including, but not limited to, servers, desktop computers, laptops, mobile devices, workstations and other computing devices. Request classification program 130 can be executable to receive and store data over a network and can include instructions that are stored at a number of different locations and are executed in a distributed manner. While shown as a stand alone program in FIG. 6, it should be noted that request classification program 130 can be a module of a larger program, can comprise separate programs operable to communicate data to each other via or can be implemented according to any suitable programming scheme.

Embodiments of the present invention can be implemented to define transactions at any layer in a tiered architecture (e.g., at web servers, application servers, database servers or other servers or components). Various requests can be associated with transactions including HTTP, HTTPs, Macromedia Flex, streaming content requests, email system requests, Telnet requests, SMTP requests, POP requests, IMAP requests, MAPI requests, FTP requests, LDAP requests, WAP/MMS and Radius requests, TCIP/IP requests, UDP requests, COBRA requests, J2EE/EJB requests, requests according to the .NET framework, SOAP requests, ODBC requests, ADO requests, Oracle OCI requests, IBM CLI requests, IBM mainframe requests, (D)Com requests and other requests. Embodiments of the present invention can also be configured to classify requests from various software systems including SAP systems, PeopleSoft systems, Siebel systems, Oracle applications, Chordiant systems, Epiphany systems, Lawson systems, BEA Tuxedo applications and other systems and applications that can be deployed at various layers of a network. By classifying requests according to transactions at various layers of a network, the effects of a user action can be traced through the entire process of responding to that action.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the scope of this invention as claimed below.

1-37. (canceled)

38. A computer program product comprising a set of computer instructions stored on a computer readable medium and executable by a computer processor, the set of computer instructions comprising instructions executable to:
record requests directed to a server application;
associate the recorded requests with transactions;
automatically generate identification rules associated with the transactions based on the content of the recorded requests to classify subsequent requests as corresponding to particular transactions; and
update the identification rules based upon the analysis of new requests.

39. The computer program product of claim 38, wherein the set of computer instruction comprise instructions executable to:
select a set of requests for further processing;
associate each request in the set of requests with a transaction from a set of transactions; and
automatically generate one or more identification rules for each transaction based on the content of requests associated with that transaction, wherein each request associated with each transaction meets at least one of the one or more identification rules for that transaction.

40. The computer program product of claim 39, wherein the one or more identification rules for each transaction are not met by requests associated with any other transaction, the selected set of requests comprises requests recorded over a set of recording sessions.

41. The computer program product of claim 39, wherein the set of computer instructions further comprise instructions executable to parse each request in the set of requests to a common data model and to determine a URI of each requests and a set of contexts of each request.

42. The computer program product of claim 39, wherein the instructions to automatically generate one or more identification rules for each transaction further comprise instructions executable to:
determine a URI from a selected request associated with a selected transaction;
determine if the URI is contained in another request associated with another transaction; and
if the URI is not contained in another request associated with another transaction, generate a first identification rule for the selected transaction that classifies subsequent requests containing the URI as corresponding to the selected transaction;
if the URI is contained in another request associated with another transaction, determine one or more differentiating context sets from requests associated with the selected transaction; and
generate the first identification rule based on the URI and a selected differentiating context set that classifies a subsequent request containing the URI and the selected differentiating context set as corresponding to the selected transaction.

43. The computer program product of claim 42, further comprising instructions executable to:
for a selected request associated with the selected transaction, determine that the selected request cannot be differentiated from another request associated with another transaction;
automatically define a new transaction; and
automatically generate one or more identification rules for the new transaction.

44. The computer program product of claim 39, wherein the set of computer instructions further comprise instructions executable to:
provide a user interface that allows a user to indicate that a recording session should begin and end and to indicate the transaction from the set of transactions with which recording session requests should be associated;
present identification rules in the user interface.

45. A method, comprising: providing a system for developing identification rules to classify requests as corresponding to transactions comprising a server computer running a classification engine and one or more client computers coupled to the server computer via one or more networks;
receiving a set of requests from the one or more client computers over the one or more networks;
associating each request in the set of requests with a transaction from a set of transactions, wherein the classification engine performs the associating of each request; and
automatically generating one or more identification rules for each transaction based on the content of requests associated with that transaction, wherein each request associated with the transaction from the set of transactions meets at least one of the one or more identification rules for that transaction, wherein the classification engine performs the automatic generation of the one or more identification rules.

46. The method of claim 45, wherein the one or more identification rules for each transaction are not met by requests associated with any other transaction.

47. The method of claim 45, wherein receiving the set of requests comprises receiving the set of requests over a set of recording sessions.

48. The method of claim 45, further comprising parsing each request in the set of requests to a common data model and determining a URI of each request and a set of contexts of each request, wherein the classification engine performs the parsing.

49. The method of claim 45, wherein automatically generating one or more identification rules for each transaction further comprises, for a selected transaction:
determining a URI from a selected request associated with the selected transaction, wherein the classification engine performs the determining;
determining if the URI is contained in another request associated with another transaction, wherein the classification engine performs the determining;
if the URI is not contained in another request associated with another transaction, generating a first identification rule for the selected transaction that classifies subsequent requests containing the URI as corresponding to the selected transaction, wherein the classification engine performs the generating;
if the URI is contained in another request associated with another transaction, determining one or more differentiating context sets from requests associated with the selected transaction, wherein the classification engine performs the determining; and
generating the first identification rule based on the URI and a selected differentiating context set that classifies a subsequent request containing the URI and the selected differentiating context set as corresponding to the selected transaction, wherein the classification engine performs the generating and
for a selected request associated with the selected transaction, determining that the selected request cannot be differentiated from another request associated with another transaction, wherein the classification engine performs the generating;
automatically defining a new transaction, wherein the classification engine performs the defining; and
automatically generating one or more identification rules for the new transaction that the selected request meets, wherein the classification engine performs the generating.

50. The method of claim 45, further comprising:
receiving a new request from the one or more client computers over the one or more networks;
determining if the new request meets any identification rule associated with a first transaction, wherein the classification engine performs the determining; and
if so, associating the new request with the first transaction, wherein the classification engine performs the associating, otherwise:
associating the new request with a new transaction, wherein the classification engine performs the associating;
automatically generating one or more identification rules for the new transaction that are met by the new transaction, wherein the classification engine performs the generating;
and automatically updating the one or more identification rules for the first transaction so that they are not met by the new transaction, wherein the classification engine performs the updating.

51. The method of claim 50, further comprising:
associating the new request with a new transaction, wherein the classification engine performs the associating;
determining that the new request cannot be differentiated from a previous request associated with the first transaction, wherein the classification engine performs the determining; and
defining a crosscut transaction and generating one or more identification rules for the crosscut transaction that are met by the new transaction, wherein the classification engine performs the defining and generating.

52. A system for developing identification rules to classify requests as corresponding to transactions, comprising:
one or more client computers;
a server computer coupled to the one or more client computers over one or more networks, comprising:
a processor,
a computer readable medium, comprising instructions translatable to implement a classification engine, wherein the classification engine is configured for:
receiving a first request;
associating the first request with a first transaction;
automatically generating an identification rule for the first transaction based on the content of the first request;
receiving a second request;
associating the second request with a second transaction;
automatically generating an identification rule for the second transaction; and
updating the identification rule for the first transaction.

53. The system of claim 52, wherein generating the identification rule for the first transaction comprises:
determining if a URI of the first request is used by a previous request associated with another transaction and, if not, generating the identification rule for the first transaction based on the URI of the first request to identify subsequent requests containing the URI as corresponding to the first transaction; and
if the URI of the first request is used by a previous request associated with another transaction:
determining one or more differentiating context sets for the first transaction;
generating the identification rule for the first transaction based on the URI and at least one of the one or more differentiating context sets for the first transaction to identify subsequent requests as corresponding to the first transaction.

54. The system of claim 53, wherein the classification engine is further configured for determining that the second request meets the first identification rule.

55. The system of claim 54, wherein generating the identification rule for the second request further comprises determining one or more differentiating context sets for the second transaction; and
generating the identification rule for the second request based on the URI and at least one of the one or more differentiating context sets for the second transaction to identify subsequent requests as corresponding to the second transaction, wherein the second request meets the identification rule for the second transaction, but does not meet the updated identification rule for the first transaction and the first request meets the updated identification rule for the first transaction but does not meet the identification rule for the second transaction.

56. The system of claim 55, wherein the classification engine is further configured for filtering out requests for predefined types of content and parsing the first request and the second request to a common data model.

57. The system of claim 56, wherein the classification engine is further configured for providing a user interface that allows a user to indicate that a recording session should begin and end and to associate requests with transactions.

58. The system of claim 57, wherein the classification engine is further configured for:
receiving an indication to begin a first recording session;
recording at least the first request in the first recording session;
receiving an indication to end the first recording session;
ending the first recording session;
receiving an indication to associate the first request with the first transaction;
receiving an indication to being a second recording session;
recording at least the second request in the second recording session;
receiving an indication to the second recording session;
ending the second recording session; and
receiving an indication to associate the second request with the second transaction.
